(19) United States
(12) Patent Application Publication
(10) Pub. No.: US 2024/0269823 A1
(43) Pub. Date: Aug. 15, 2024

(54) REACHING AND GRASPING TOOL

(71) Applicant: Unger Marketing International, LLC, Bridgeport, CT (US)

(72) Inventors: William Harrington, Newtown, CT (US); Brandon M. Temple, Stamford, CT (US); Stephen P. Huda, Shelton, CT (US); James M. Buckley, New Hartford, CT (US)

(21) Appl. No.: 18/441,330

(22) Filed: Feb. 14, 2024

Related U.S. Application Data
(60) Provisional application No. 63/445,766, filed on Feb. 15, 2023.

(51) Int. Cl. B25J 1/02

(52) U.S. Cl. CPC B25J 1/02

(57) ABSTRACT

A reaching and grasping tool is provided. The tool includes a pole assembly having a plurality of pole segments slidingly coupled together. A trigger assembly having a handle body and tensioning mechanism is provided. The tensioning mechanism having a cylindrical member rotationally coupled to the handle body and a torsional biasing member operably coupled to the cylindrical member. A jaw assembly having frame, a first jaw, and a second jaw, the first jaw and second jaw being rotationally coupled to the frame. A linkage is operably coupled between the biasing member, the first jaw and the second jaw.

### CROSS-REFERENCE TO RELATED APPLICATIONS

The present application claims the benefit of, and is a nonprovisional application of, U.S. Provisional Application Ser. No. 63/445,766 filed Feb. 15, 2023 entitled “Reaching and Grasping Tool” the contents of which are incorporated herein by reference.

### BACKGROUND OF THE DISCLOSURE

The subject matter disclosed herein relates to for picking up or grabbing objects, and in particular to a reaching and grasping tool that has an adjustable length.

Reaching and grasping tools have proven useful to extend the reach of users to, for example, grasp items above the user (e.g., on a shelf) or below the user (e.g., on the ground).

These type of tools may be configured with pistol or trigger style grips. Other tools in this category are also known to be configured with inline style grips. Additionally, the tools are known to be configured with one or more features such as rotating gripping heads, telescoping extensions, and others.

While existing reaching and grasping tools re suitable for their intended purposes the need for improvement remains, particularly in providing reaching and grasping tool having the features described herein.

### BRIEF DESCRIPTION OF THE DISCLOSURE

According to one aspect of the disclosure a reaching and grasping tool is provided. The tool includes a pole assembly having a plurality of pole segments slidingly coupled together. A trigger assembly having a handle body and tensioning mechanism is provided. The tensioning mechanism having a cylindrical member rotationally coupled to the handle body and a torsional biasing member operably coupled to the cylindrical member. A jaw assembly having frame, a first jaw, and a second jaw, the first jaw and second jaw being rotationally coupled to the frame. A linkage is operably coupled between the biasing member, the first jaw and the second jaw.

In addition to one or more of the features described herein, or as an alternative, further embodiments of the tool may include the linkage being made from a thin metallic strip of material.

In addition to one or more of the features described herein, or as an alternative, further embodiments of the tool may include the thin metallic strip being wound around the cylindrical member.

In addition to one or more of the features described herein, or as an alternative, further embodiments of the tool may include the trigger assembly having an actuator rotationally coupled to the handle body, the actuator being operably coupled to rotate the cylindrical member when the actuator is moved from a first position towards a second position.

In addition to one or more of the features described herein, or as an alternative, further embodiments of the tool may include the cylindrical member having a first plurality of gear teeth and the actuator includes a second plurality of gear teeth, the first plurality of gear teeth and second plurality of gear teeth cooperating to rotate the cylindrical member when the actuator is moved.

In addition to one or more of the features described herein, or as an alternative, further embodiments of the tool may include a hinge coupled between one of the plurality of pole segments and the frame, the linkage extending through the hinge.

In addition to one or more of the features described herein, or as an alternative, further embodiments of the tool may include the first jaw and second jaw each having at least one engagement feature.

In addition to one or more of the features described herein, or as an alternative, further embodiments of the tool may include the at least engagement feature being at least one of a plurality of u-shaped slots, a plurality of ribs, and a plurality of teeth.

These and other advantages and features will become more apparent from the following description taken in conjunction with the drawings.

### BRIEF DESCRIPTION OF DRAWINGS

The subject matter, which is regarded as the disclosure, is particularly pointed out and distinctly claimed in the claims at the conclusion of the specification. The foregoing and other features, and advantages of the disclosure are apparent from the following detailed description taken in conjunction with the accompanying drawings in which:

FIG. 1 is a top perspective view of a reaching and grasping tool in accordance with an embodiment;

FIG. 2 is an enlarged partial perspective view of a first end of the reaching and grasping tool of FIG. 1;

FIG. 3 is an enlarged partial perspective view of a second end of the reaching and grasping tool of FIG. 1;

FIG. 4 is a first side view of the reaching and grasping tool of FIG. 1;

FIG. 5 is a second side view of the reaching and grasping tool of FIG. 1;

FIG. 6 is a top view of the reaching and grasping tool of FIG. 1;

FIG. 7 is a bottom view of the reaching and grasping tool of FIG. 1;

FIG. 8 is a first end view of the reaching and grasping tool of FIG. 1;

FIG. 9 is a second end view of the reaching and grasping tool of FIG. 1;

FIG. 10 is a partial perspective view of the trigger assembly for the reaching and grasping tool of FIG. 1 in accordance with an embodiment;

FIG. 11 is a partial sectional view of the jaw assembly for the reaching and grasping tool of FIG. 1 in accordance with an embodiment;

FIG. 12 is another partial sectional view of the jaw assembly for the reaching and grasping tool of FIG. 1 in accordance with an embodiment;

FIG. 13 is a perspective view of the reaching and grasping tool of FIG. 1; and

FIG. 14 is another partial sectional view of the jaw assembly for the reaching and grasping tool of FIG. 1 in accordance with another embodiment.

The detailed description explains embodiments of the disclosure, together with advantages and features, by way of example with reference to the drawings.

### DETAILED DESCRIPTION OF THE DISCLOSURE

Embodiments of the present disclosure provide for a reaching and graphing tool having a length that may be selectively changed to allow the distance from the jaws to the trigger to be changed. Still further embodiments of the present disclosure provide for an actuation mechanism that automatically adjusts to allow the changing of a pole length. Still further embodiments of the present disclosure provide for a reaching and grasping tool having jaws that allow for objects to be held using multiple engagement features. Still further embodiments of the present disclosure provide from a jaw assembly that may be selectively angled relative to a central axis of the tool.

Referring now to FIGS., an embodiment of a reaching and grasping tool 100 having a jaw assembly 102, a trigger assembly 104 and an extendable pole assembly 106. The jaw assembly 102 includes a first jaw 108 and a second jaw 110 that are configured to rotate about axis 112, 114 respectively to move between a closed and an open position. When in the open position the ends 116, 118 of the jaws 108, 110 are separated.

In an embodiment, each jaw 108, 110 include an end 116, 119 that is opposite the pivot portions 120, 122 that couple to pivots 124, 126. The pivots 124, 126 define the axis 112, 114. In an embodiment, the pivots 124, 126 are defined by a frame 128 having a slot that receives the pivot portions 120, 122. In an embodiment, the pivots 124, 126 are defined by a pin (not shown for clarity) extends through openings in the frame 128.

The jaws 108, 110 each include an arm portion 130, 132 having an arcuate shape that extends between the pivot portions 120, 122 and the ends 116, 118. In an embodiment, the interface of the arm portion 130, 132 and the end 116, 118 includes an angled surface 134, 136 that extends on an angle inwardly relative to a plane extending through the center of the tool 100. In an embodiment, the jaws 108, 110 each include a plurality of engagement features that facilitate the grasping of objects (e.g. debris on the ground, a jar on a shelf, or a tree branch). In the illustrated embodiment a first engagement features 138 are defined by a plurality of u-shaped slots 140 that extend through the width on opposing inner surfaces of the ends 116, 118. The slots 140 are inwardly facing when the jaws 108, 110 are in the closed position. A second engagement feature includes a plurality of projections, such as semi-cylindrical ribs 142 that are disposed on an inside surface of the arm portions 130, 132. A third engagement feature may include a plurality of teeth 144 formed on opposing inner surfaces of the pivot portions 120, 122. In an embodiment, the teeth 144 are defined by a plurality of adjacent triangularly shaped slots that extend through the width of the pivot portions 120, 122. It should be appreciated that while the illustrated embodiment shows three engagement features, this is for example purposes and the claims should not be so limited. In other embodiments, the jaws 108, 110 may have no engagement features, one engagement feature, two engagement features, or three or more engagement features.

The frame 128 includes a body portion 146 that extends in a direction away from the jaws 108, 110. The body portion 146 is rotationally coupled to an end connector 148 arranged on an end of the last segment of the pole assembly 106. In the illustrated embodiment, the body portion 146 is coupled to the end connector 148 by a hinge 150 that allows the selective rotation of the jaw assembly 102 about an axis 152. The hinge 150 may include a pin (not shown) that extends coaxially with the axis 152 and has fasteners on at least one end to allow the hinge 150 to be locked in a desired angular position. In an embodiment, the hinge 150 allows for continuous rotation of the jaw assembly 102. In another embodiment, the hinge 150 allows rotation of the jaw assembly 102 in discrete increments.

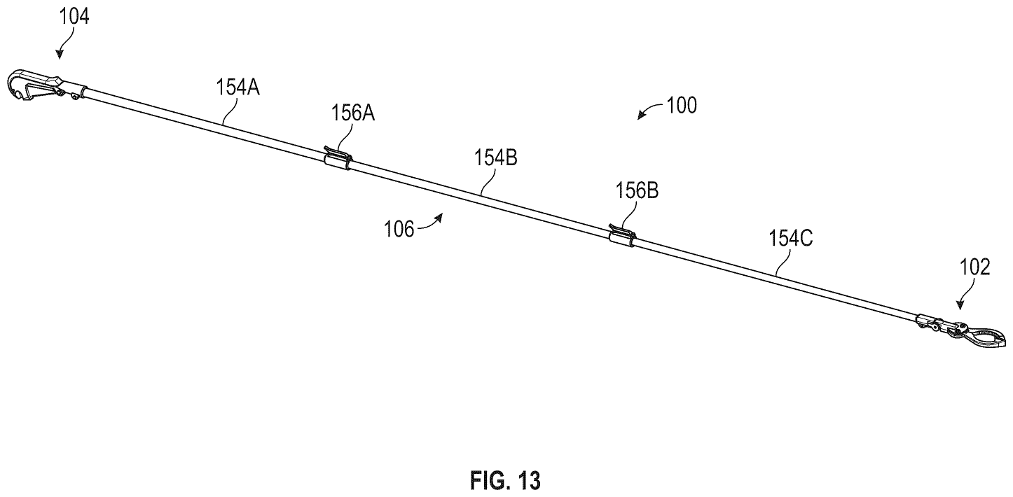

The extendable pole assembly 106 is comprised of a plurality of pole segments, such as pole segments 154A, 154B, 154C (FIG. 13) for example, that are arranged in a telescopic manner. In other words, the pole segments are slidably coupled to each other such that the pole segment 154C may be selectively slid into pole segment 154B, which in turn may be selectively slid into pole segment 154A. It should be appreciated that while the illustrated embodiment shows three pole segments, this is for example purposes and the tool 100 may have more or fewer pole segments than shown without deviating from the teachings provided herein. The pole segments except for the last pole segment, e.g. pole segments 154A, 154B, each have a clamping mechanism 156A, 156B that allows for the selective sliding and locking/fixing of the adjacent pole segment. In an embodiment, the clamping mechanism 156A, 156B includes a lever that is operably coupled to a clamping arrangement that allows for selective locking and releasing of the adjacent pole segment. Each of the pole segments is tubular, having a hollow center portion. As will be discussed in more detail herein, the hollow center portion is sized to allow a linkage to pass therethrough.

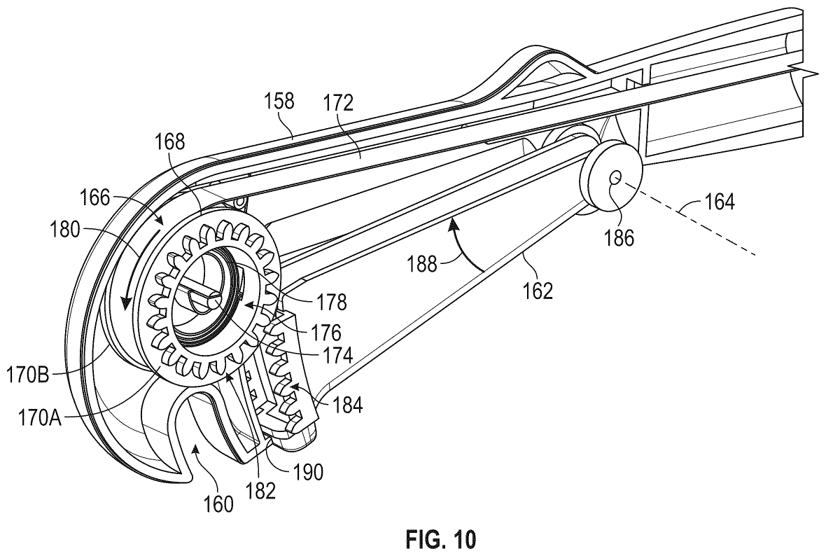

On an opposite side of the pole assembly 106 from the jaw assembly 102 is a trigger assembly 104. In the illustrated embodiment, the trigger assembly 104 couples to the end of pole segment 154A. The trigger assembly 104 includes a body 158 formed from two halves. The body 154 includes an optional slot 160 that may be used to hang the tool 100 on a wall. Pivotally coupled to the body 158 is an actuator 162. The actuator 162 is rotationally coupled to the body 158 to rotate about an axis 164. In an embodiment, a biasing member, such as a torsion spring (not shown) for example is operably coupled to the actuator 162 to bias the actuator counter-clockwise (from the view point of FIG. 10) to assist in allowing the actuator to return to the position shown in FIG. 10).

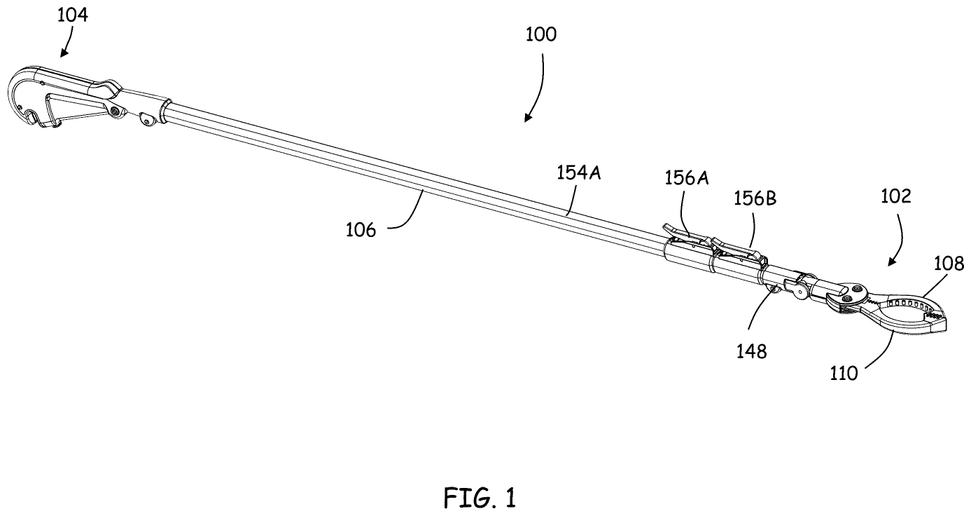

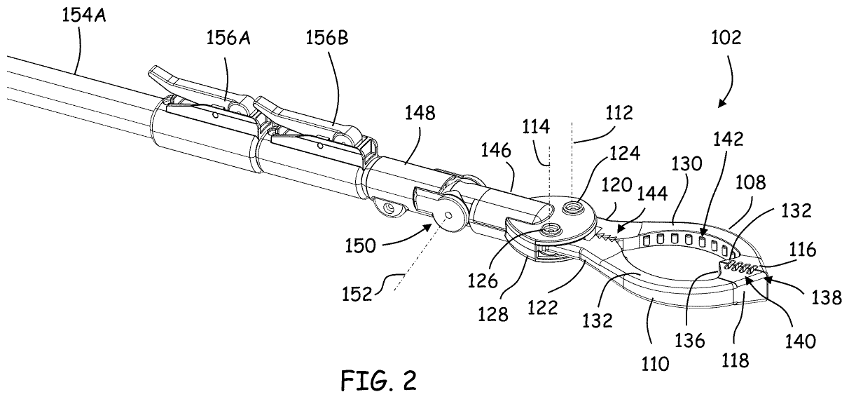

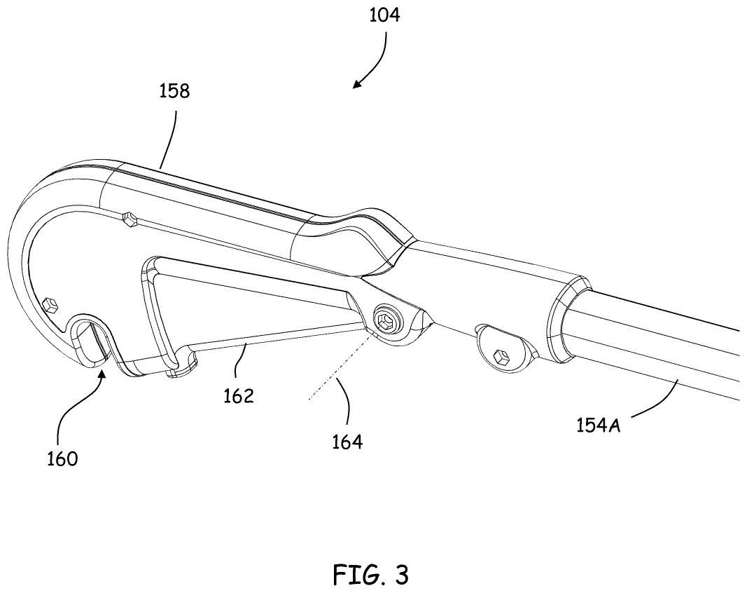

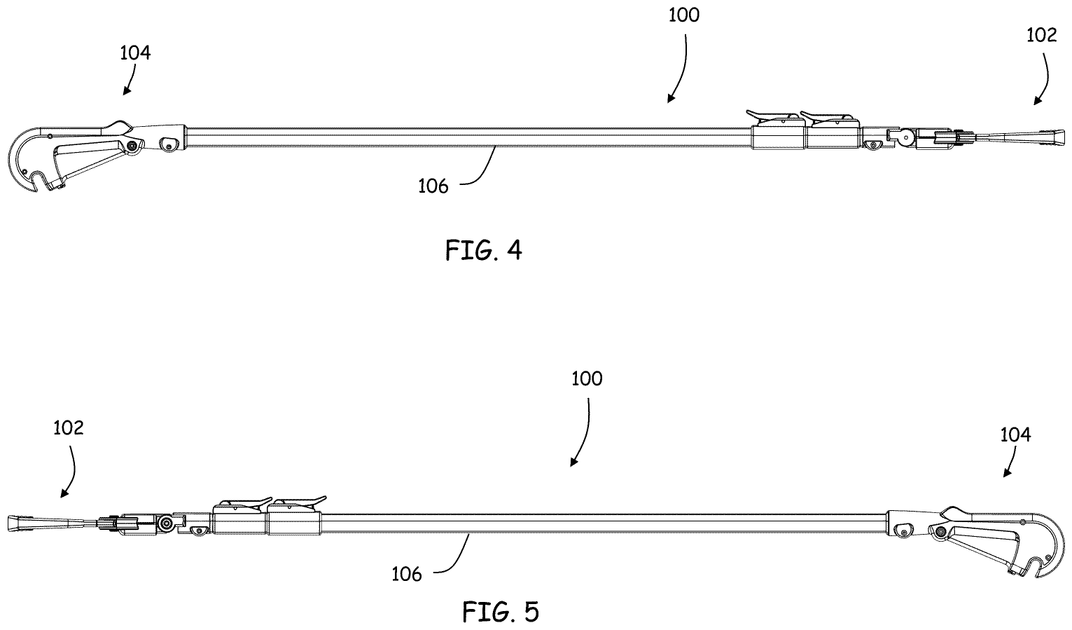

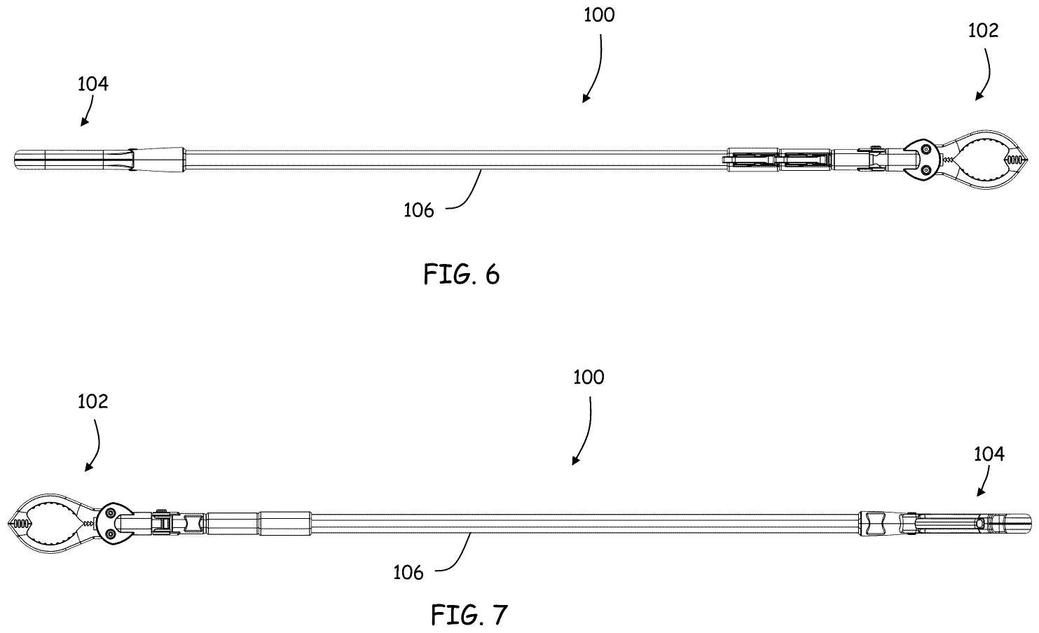

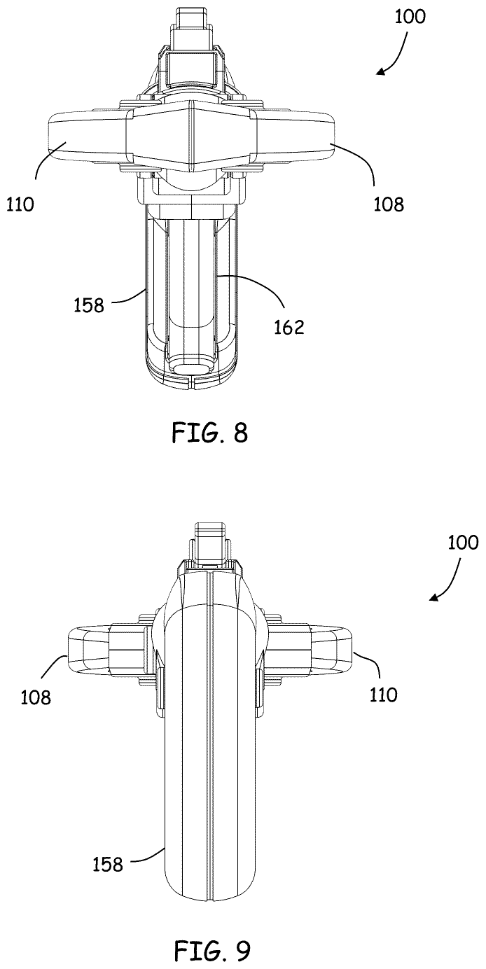

Referring now to FIG. 10, an embodiment is shown of a tensioning mechanism 166. The tensioning mechanism 166 includes a cylindrical member 168 having a pair of sidewalls 170A, 170B on opposite ends that define a slot therebetween. The slot is sized to receive a linkage 172. In the illustrated embodiment, the linkage 172 is made from a thin wide material, similar to a tape measure. The linkage 172 is wound around the cylindrical member 168. The cylindrical member 168 is sized to allow sufficient storage of linkage 172 to allow the plurality of pole segments to be slid from a first position (FIG. 1) with each of the pole segments substantially slid into the first pole segment 154A and an second extended position (FIG. 13) with the pole segments extended.

The cylindrical member 168 rotates about a pin 174 that extends through the sidewall 170B to rotationally couple the cylindrical member 168 to the body 158. The cylindrical member 168 has a substantially hollow interior 176. Disposed within the hollow interior 176 is a biasing member, such as a torsion or clock-spring 178. In the illustrated embodiment, the clock-spring 178 has a first end coupled to the interior wall of the cylindrical member 168 and a second end coupled to the pin 174. The clock-spring 178 biases the cylindrical body 168 in the direction of arrow 180 (counterclockwise from the view of FIG. 10) to keep the linkage 172 in tension. It should be appreciated that as the pole segments 154A, 154B, 154C are extended, the force of extension overcomes the biasing force of the clock-spring 178 and unwinding the linkage 172 from the cylindrical member 168. It should be further appreciated that as the pole segments are moved from an extended position to a retracted position, the biasing force of the clock-spring 178 causes the cylindrical member 168 to rotate and wind the linkage 172 back onto the cylindrical body.

In the embodiment of FIG. 10, the sidewall 170A includes a plurality of gear teeth 182 that extend therefrom. In the illustrated embodiment, the gear teeth 182 are involute gear teeth. The gear teeth 182 engage and cooperate with gear teeth 184 arranged on an end of the actuator 162 opposite the pivot 186. The pivot 186 rotates about a pin (not shown) that is coupled to the body 158 and is coaxial with the axis 164. When the tool operator squeezes the actuator 162, the actuator rotates about the pivot 186 in the direction indicated by arrow 188. As the actuator 162 rotates, the gear teeth 184 engage the gear teeth 182, force from the operator squeezing the actuator 162 overcomes the biasing force of the clock-spring 178 causing the cylindrical member 168 to rotate in the direction of arrow 180 causing the linkage 172 to wind onto the cylindrical member 168. As will be discussed in more detail herein, the winding of the linkage 172 onto the cylindrical member 168 causes the jaws to move from the closed position towards an open position.

When the operator releases the actuator 162, the biasing force of the clock-spring 178 rotates the cylindrical member 168 in the direction opposite that indicated by arrow 180. In this motion, the gear teeth 182 engage the gear teeth 184 and cause the actuator 162 to rotate back to the position shown in FIG. 10. In an embodiment, the actuator 162 includes a projection 190 that acts as a stop against an inside surface of the body 158 and prevents further rotation of the actuator 162.

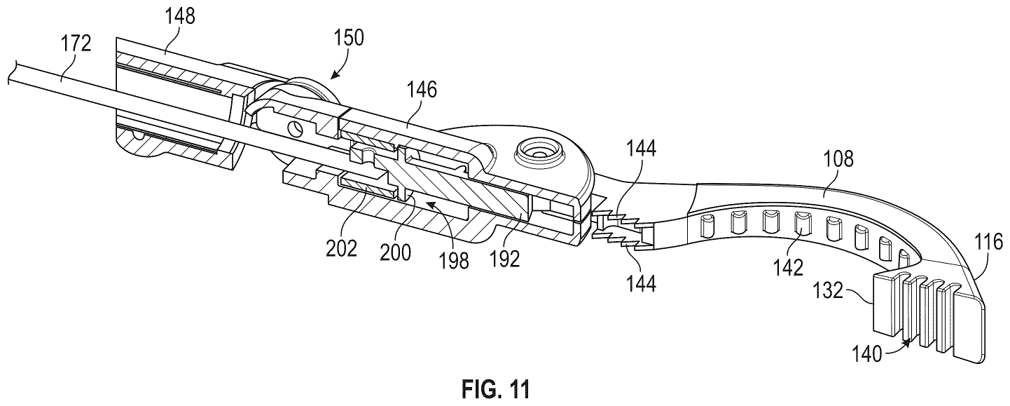

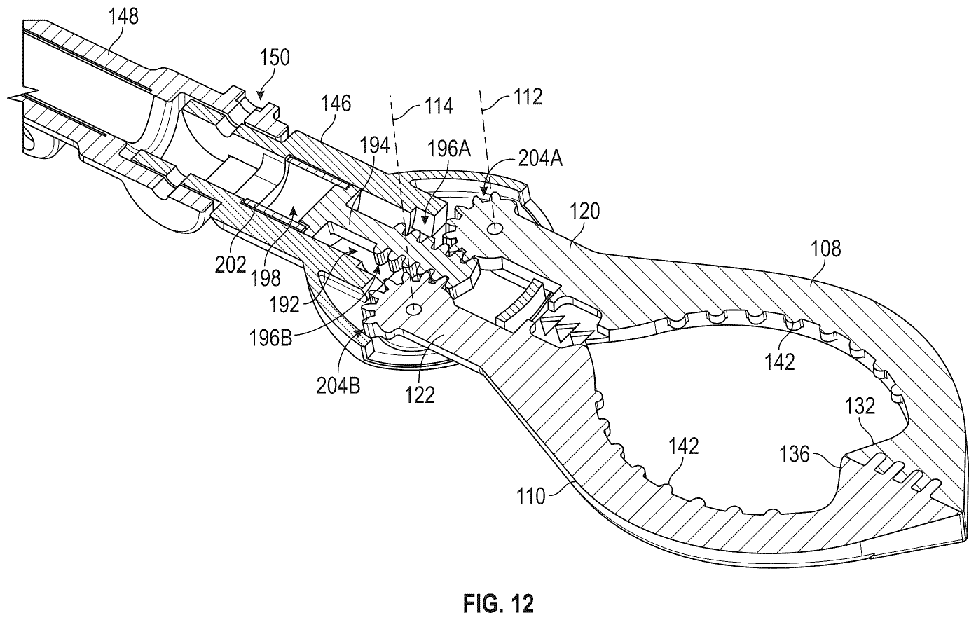

Referring now to FIG. 11 and FIG. 12 an embodiment is shown of the jaw assembly 102. The linkage 172 extends through the length of the pole assembly 106, through the hinge 150 and couples to a rack member 192. In an embodiment, the linkage 172 is coupled to the rack member 192 by a pin (not shown). The rack member 192 includes a body portion 194 and a pair of opposing linear rack gear teeth 196A, 196B. The body portion 194 is substantially disposed within a hollow area 198 of the frame body portion 146. In an embodiment, the body portion 194 includes a flange 200 that is sized to fit closely within the hollow area 198 to allow the rack member 192 to translate relative to the frame body portion 146. In an embodiment a biasing member, such as a compression spring 202, is positioned between the flange 200 and an end wall of the hinge 150 to bias the rack member 192 in a direction away from the trigger assembly 104.

In an embodiment, the rack gear teeth 196A, 196B are positioned to engage pinion gear teeth 204A, 204B arranged on the ends of the pivot portions 120, 122 and are positioned to rotate about the pivots 124, 126. It should be appreciated that when the rack member 192 is moved in a direction away from the trigger assembly 104 (e.g. under the biasing force of spring 202), the engagement of the rack gear teeth 196A, 196B on the pinion gear teeth 204A, 204B will cause the jaws 108, 110 to rotate about the pivots 124, 126 into an open position allowing the operator to grasp an object. By squeezing the actuator 162, the linkage 172 overcomes the biasing force of the spring 202 and slides the rack member 192 towards the hinge 150. This in turn causes the rack gear teeth to engage the pinion gear teeth and rotate the jaws 108, 110 towards a closed position.

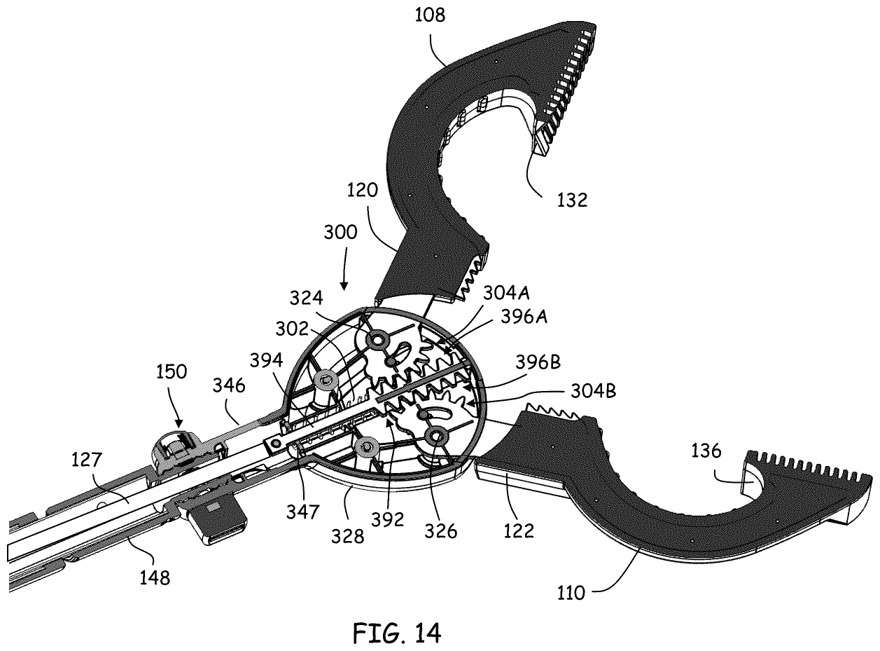

Referring now to FIG. 14, an another embodiment is shown of the jaw end 300 of the reaching and grasping tool 100. In this embodiment, the rack gear teeth 396A, 396B are positioned to engage pinion gear teeth 304A, 304B arranged on the ends of the pivot portions 120, 122 and are positioned to rotate about the pivots 324, 326. It should be appreciated that when the rack member 392 is moved in a direction away from the trigger assembly 104 (e.g. under the biasing force of spring 302), the engagement of the rack gear teeth 396A, 396B on the pinion gear teeth 304A, 304B will cause the jaws 108, 110 to rotate about the pivots 324, 326 into an open position allowing the operator to grasp an object. By squeezing the actuator 162, the linkage 172 overcomes the biasing force of the spring 302 and slides the rack member 392 towards the hinge 150. This in turn causes the rack gear teeth to engage the pinion gear teeth and rotate the jaws 108, 110 towards a closed position.

In the embodiment of FIG. 14, the spring 302 is positioned between the first tooth of the rack member 292 and wall 347 positioned in the body portion 346 of frame 328. The wall 347 includes an opening that allows a body portion 394 of the rack member 392 to extend therethrough. The linkage 172 couples to the end of the body portion 394. In an embodiment, the pinion gear teeth 304A, 304B are sized to allow about 90 degrees of rotation. It should be appreciated that the rack member 392 and pinion gear teeth may be configured to allow more or less rotational travel of the jaws 108, 110.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It should also be noted that the terms “first”, “second”, “third”, “upper”, “lower”, and the like may be used herein to modify various elements. These modifiers do not imply a spatial, sequential, or hierarchical order to the modified elements unless specifically stated.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments described herein.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description, but is only limited by the scope of the appended claims.

What is claimed is:

1. A reaching and grasping tool comprising:
a pole assembly having a plurality of pole segments slidingly coupled together;
a trigger assembly having a handle body and tensioning mechanism, the tensioning mechanism having a cylindrical member rotationally coupled to the handle body and a torsional biasing member operably coupled to the cylindrical member;
a jaw assembly having frame, a first jaw, and a second jaw, the first jaw and second jaw being rotationally coupled to the frame; and
a linkage operably coupled between the torsional biasing member, the first jaw and the second jaw.

2. The tool of claim 1, wherein the linkage is made from a metallic strip of material.

3. The tool of claim 2, wherein the metallic strip is wound around the cylindrical member.

4. The tool of claim 3, wherein the trigger assembly includes an actuator rotationally coupled to the handle body, the actuator being operably coupled to rotate the cylindrical member when the actuator is moved from a first position towards a second position.

5. The tool of claim 4, wherein the cylindrical member includes a first plurality of gear teeth and the actuator includes a second plurality of gear teeth, the first plurality of gear teeth and second plurality of gear teeth cooperating to rotate the cylindrical member when the actuator is moved.

6. The tool of claim 1, further comprising a hinge coupled between one of the plurality of pole segments and the frame, the linkage extending through the hinge.

7. The tool of claim 1, wherein the first jaw and second jaw each include at least one engagement feature.

8. The tool of claim 7, wherein the at least one engagement feature is at least one of a plurality of u-shaped slots, a plurality of ribs, and a plurality of teeth.

9. A reaching and grasping tool comprising:
a pole assembly having a first pole segment slidingly coupled to a second pole segment;
a trigger assembly having a rotatable tensioning mechanism, the tensioning mechanism having a cylindrical member and a torsional biasing member operably coupled to the cylindrical member;
a jaw assembly having a first jaw and a second jaw, the first jaw and second jaw being rotatable relative to each other; and
a linkage operably coupled between the torsional biasing member, the first jaw and the second jaw.

10. The tool of claim 9, wherein the linkage is made from a metallic strip of material.

11. The tool of claim 10, wherein the metallic strip is wound around the cylindrical member.

12. The tool of claim 11, wherein the trigger assembly includes a handle body and an actuator rotationally coupled to the handle body, the actuator being operably coupled to rotate the cylindrical member when the actuator is moved from a first position towards a second position.

13. The tool of claim 12, wherein the cylindrical member includes a first plurality of gear teeth and the actuator includes a second plurality of gear teeth, the first plurality of gear teeth and second plurality of gear teeth cooperating to rotate the cylindrical member when the actuator is moved.

14. The tool of claim 9, further comprising a hinge operably coupled between the second pole segment and the first jaw, the linkage extending through the hinge.

15. The tool of claim 9, wherein the first jaw and second jaw each include at least one engagement feature.

16. The tool of claim 15, wherein the at least one engagement feature is at least one of a plurality of u-shaped slots, a plurality of ribs, and a plurality of teeth.

17. A reaching and grasping tool comprising:
a pole assembly having a first pole segment slidingly coupled to a second pole segment;
a trigger assembly having a rotatable tensioning mechanism, the tensioning mechanism having a cylindrical member and a torsional biasing member operably coupled to the cylindrical member;
a jaw assembly having frame, a first jaw, and a second jaw, the first jaw and second jaw being rotatably coupled to the frame;
a hinge coupled between the second pole segment and the frame, and
a linkage operably coupled between the torsional biasing member, the first jaw and the second jaw.

18. The tool of claim 17, wherein the hinge is configured to selectively lock in an angular position.

19. The tool of claim 18, wherein the hinge is rotatable in discrete angular increments.

20. The tool of claim 18, wherein:
the hinge is configured to rotate about a first axis;
the first jaw is rotatable about a second axis; and
the first axis is perpendicular to the second axis.
